(19) United States
(12) Patent Application Publication
(10) Pub. No.: US 2008/0038176 A1
(43) Pub. Date: Feb. 14, 2008

(54) Unsymmetrical Inorganic Particles, and Method for Producing the Same

(75) Inventors: Etienne Duguet, Begles (FR); Celine Poncet-Legrand, Montpellier (FR); Serge Ravaine, Cestas (FR); Elodie Bourgeat-Lami, Nievroz (FR); Stephane Reculusa, Bayonne (FR); Christophe Mingotaud, Toulouse (FR); Marie-Helene Delville, Talence (FR); Franck Pereira, Joue-les-Tours (FR)

Correspondence Address: BUCHANAN, INGERSOLL & ROONEY PC, POST OFFICE BOX 1404, ALEXANDRIA, VA, 22313-1404, US

(73) Assignees: Centre National De La Recherche Scientifique, Paris (FR); Cpe Lyon Formation Continue Et Recherche, Villeurbanne (FR); Universite Paul Sabatier, Toulouse (FR); Universite Des Sciences Et Technologies, Talence (FR)

(21) Appl. No.: 10/579,247

(22) PCT Filed: Nov. 4, 2004
(86) PCT No.: PCT/FR04/02836

§ 371 Date: Mar. 20, 2007

(30) Foreign Application Priority Data
Nov. 13, 2003 (FR) 0313273

(51) Int. Cl. B01J 13/22; C09C 1/30

(52) U.S. Cl. 423/328.1; 423/335; 423/579; 423/610; 423/625; 423/632; 423/659

(57) ABSTRACT

The invention relates to unsymmetrical nanoscale or mesoscopic particles, and to a method for preparing the same.

Said particles are characterized by a surface F1 and the zone Z2 carries groups F2 different from the groups F1, the zone Z1 being free of groups F2 and the zone Z2 being free of groups F1.

The method of preparation comprises the following steps: 1) the zone Z2 of the surface of the initial particles is masked by fixing a polymer nodule thereto; 2) the masked particles obtained at the end of step 1) are treated in order to modify the nonmasked surface zone Z1 thereof; 3) the polymer nodule is removed after modifying the zone Z1; 4) optionally, the surface of the zone Z2 of the particles is modified following the demasking process.

### FIELD OF THE INVENTION

The present invention relates to nanoscale or mesoscopic inorganic particles carrying, in a regioselective manner, two chemically or biochemically different functionalities, and also to a method for preparing the same.

### BACKGROUND OF THE INVENTION

Unsymmetrical nanoscale or submicron particles carrying, at their surface, various functionalities have been widely studied with a view to developing the use thereof in various technical fields. Thus, particles carrying hydrophilic groups and hydrophobic groups distributed anisotropically at their surface can be used to stabilize emulsions.

WO 01/85324 (Chane-Ching) describes a method for preparing solid particles that are amphiphilic in nature. The method consists in partially modifying the surface of an inorganic nanoparticle with organic chains that are hydrophobic in nature. The product obtained is an emulsifying composition comprising nanoscale inorganic particles having a core made of inorganic material and a hydrophobic organic coating on part of its surface, the hydrophobic coating being obtained in particular by covalent bonding using a compound comprising a long alkyl chain and a silanol group.

WO 03/039724 (Chane-Ching) describes emulsions stabilized with solid inorganic nanoscale particles, attached to the surface of which are organic chains that are hydrophobic in nature. The inorganic particles (oxide, hydroxide, oxyhydroxide, for example silica) have an intrinsic hydrophilic nature and a hydrophobic nature provided by appropriate organic groups fixed to their surface. The particles are obtained by means of a method consisting in forming a hydrophobic phase and an aqueous dispersion of nanoscale colloidal particles having a hydrophilic surface, one of the two phases comprising a molecular surfactant capable of associating with the colloidal particles in defined proportions; adding one of the phases to the other; subjecting the mixture to an emulsification; and recovering the stabilizing agents present at the interfaces of the emulsion obtained, in the form of a dispersion in an aqueous or hydrophobic medium, or in the form of a dry powder. Another method consists in forming an emulsion integrating molecular surfactants and nanometric colloidal particles of metal oxide, hydroxide or oxyhydroxide, having a non-zero surface charge at water/oil-type interfaces; fixing, by covalent bonding, to the surface of said particles thus anchored at the water/oil-type interfaces, organic chains that are at least predominantly hydrophobic in nature, using a reactant soluble in the continuous phase and comprising an organic chain that is at least predominantly hydrophobic in nature; at least partially eliminating the molecular surfactants present at the end of the 2nd step; recovering the particles with a modified surface, obtained at the water/oil-type interfaces, in the form of a dispersion in an aqueous or hydrophobic medium, or in the form of a dry powder.

WO 03/039725 (Chane-Ching) describes the preparation of inorganic particles of phosphate or of vanadate, attached to the surface of which are organic chains that are hydrophobic in nature, the bonds between the chains and the surface of the particles being distributed nonhomogeneously, which confers on the particles an effective amphiphilic nature. An emulsifying composition containing the amphiphilic particles can be prepared by means of a method consisting in forming a hydrophobic phase and an aqueous dispersion of nanoscale colloidal particles (of phosphate or of vanadate), one of the two phases comprising a molecular surfactant capable of associating with the colloidal particles in defined proportions; adding one of the phases to the other; subjecting the mixture to an emulsification.

In the various Chane-Ching documents of the abovementioned prior art, each particle can be divided, by a straight plane of section, into two surfaces S1 and S2 such that each of the surfaces S1 and S2 represents at least 20% of the total surface of the nanoparticle; and the surface density of organic chains attached to S2 is greater than at least 5 times the surface density of chains that are hydrophobic in nature, attached to S1. It thus appears that the particles have a zone carrying predominantly but not exclusively hydrophilic surface groups, and a zone carrying predominantly but not exclusively hydrophobic surface groups.

A method for preparing silica particles at the surface of which are fixed small polystyrene particles is also known. Said method comprises a first step during which a suspension of silica particles is prepared, a second step during which a hydrophilic PEG methacrylate micromonomer is adsorbed onto said silica particles, and a third step during which an emulsion polymerization of styrene is carried out in the presence of the modified silica particles. The particles obtained by means of this method consist of a silica core and of small nodules of polymer distributed evenly at the surface of the silica core (cf. Syntheses of Raspberrylike Silica/Polystyrene Materials, S. Reculusa, et al., Chem. Mater. 2002, 14 2354-2359).

The various methods of the prior art do not, however, make it possible to obtain a large amount of nanoparticles, the surface of which is functionalized in a regioselective manner.

### SUMMARY OF THE INVENTION

The aim of the present invention is to provide nanoscale or mesoscopic inorganic particles carrying, in a regioselective manner, two chemically or biochemically different functionalities. The term “nanoscale” is intended to mean dimensions of between 1 nm and 100 nm. The term “mesoscopic dimensions” is intended to mean dimensions of between 100 nm and 1 μm.

The particles according to the present invention are nanoscale or mesoscopic particles consisting of an inorganic material. They are characterized in that their surface is divided into two zones Z1 and Z2, the zone Z1 carries groups F1 and the zone Z2 carries groups F2 different from the groups F1, the zone Z1 being free of groups F2 and the zone Z2 being free of groups F1. The area of each zone represents at least 5% of the total area of a particle, preferably at least 10%, more particularly at least 20%.

The particles of the invention are hereinafter referred to as “unsymmetrical particles”.

The inorganic material A can be a mineral oxide or a metal. The mineral oxide can be chosen, for example, from silica, iron oxides, aluminosilicates (such as, for example, clays and zeolites), titanium dioxide or alumina. The metal can be chosen, for example, from metals that are stable in an aqueous medium (for example, gold, silver and palladium). Silica is particularly preferred as inorganic material A.

The functional groups F1 and F2 can be chosen from numerous functional groups, according to the uses envisioned for the unsymmetrical particles of the invention. For example, when the unsymmetrical particles are intended to stabilize emulsions, F1 will be a hydrophilic group and F2 a hydrophobic group.

### DETAILED DESCRIPTION OF THE PREFERRED EMBODIMENTS

The unsymmetrical particles of the invention can be prepared from nanoscale or mesoscopic inorganic particles (hereinafter referred to as “initial particles”) by means of a method which comprises the following steps:
1) masking a zone Z2 of the surface of the initial particles by fixing a polymer nodule thereto;
2) treating the masked particles obtained at the end of step 1) in order to modify the nonmasked surface zone Z1 of said particles;
3) removing the polymer nodule after modifying the zone Z1;
4) optionally, modifying the surface of the zone Z2 of the particles following the demasking process.

The initial particles used in step 1) of the method of the invention may have the shape of a sphere, an ellipse, a disk, a block or a rod. In a preferred embodiment, the initial particles have a substantially spherical shape.

The polymer used for masking the zone Z2 of the surface of the initial particles comprises recurrent units —CH₂—CRR′—, which may be identical or different, in which:
R represents H or an alkyl group,
R′ represents H, an alkyl group, an aryl group, an alkylaryl group, an alkenylaryl group, a pyridyl group, a nitrile group, a group —COOR″ or a group —OC(O)R″ in which R″ is H, an alkyl or an alkenyl.

A substituent R, R′or R″ which represents an alkyl group or an aryl group can carry a functional group chosen, for example, from halides and amino groups.

Said polymer constituting the nodule can be crosslinked or noncrosslinked.

A polystyrene or a copolymer of styrene and of divinylbenzene is particularly preferred as material for the polymer nodule.

The particles obtained at the end of step 1), consisting of an inorganic part and a polymer nodule, will hereinafter be referred to as “hybrid particles”.

Step 1) can advantageously be carried out according to the method for preparing nanoscale or mesoscopic hybrid particles described in patent application FR02/13800 filed on Nov. 5, 2002. Said method comprises the following steps:

1a) modifying the surface of the initial particles using a coupling agent C which comprises a function F_{C} which has an affinity for one or more precursors of the polymer B;

1b) bringing the modified initial particles obtained at the end of step 1a) into contact with the precursor(s) of the polymer B, in the presence of a free-radical initiator and of a surfactant in solution in a solvent, in proportions that allow the formation of one polymer nodule per initial particle.

For step 1a), it is advantageous to use an amount of coupling agent that corresponds to approximately 0.1 mol of coupling agent per m² of surface of silica particle.

If Np denotes the number of polymerization seeds, SA the surfactant and I the free-radical initiator, then the number of polymerization seeds can be estimated, as a first approximation, by means of the relationship Np≈[SA]^{0.6}[I]^{0.4}. For each particular case, according to the number of particles A present in the reaction medium and to their size, the operator will perform preliminary trials, that are within the scope of those skilled in the art, by varying the concentrations of SA and of I, in order to determine the optimum concentrations. Another procedure consists in fixing the amount of monomer, of initiator and of surfactant, and also the reaction time and temperature, and in performing trials with various concentrations of silica particles having a given size, in order to determine the optimum amount of said particles. This second embodiment is particularly preferred. The implementation of steps 1a) and 1b) of the method makes it possible to obtain unsymmetrical particles in the form of a colloidal solution in a solvent.

The implementation of steps 1a) and 1b) of the method makes it possible to obtain hybrid particles in the form of a colloidal solution, which can be used as it is for step 2).

For step 1a) of the method, it is preferable to use initial inorganic particles having a narrow size distribution, in order to obtain hybrid particles of the same nature. In fact, during step 1b), the polymer nodules that form all have substantially the same size. With larger or smaller inorganic particles, hybrid particles in the shape of a snowman will form. With inorganic particles of the same size, hybrid particles in the shape of a dumbbell will form. Very small inorganic particles may not attach a nodule, and very large inorganic particles may attach two nodules. The initial inorganic particles are preferably used, for step 1a), in the form of a colloidal suspension for which the solids content is between 2 and 35%, preferably from 10 to 25%, and for which the pH is adjusted so as to allow the interaction with the coupling agent C.

The implementation of the masking method described above is particularly suitable for silica particles having a diameter of approximately 100 nm. Such particles can be obtained by sol-gel processing, well known in particular under the name Stober process. According to this process, a basic aqueous-alcoholic solution is prepared by adding an aqueous solution of ammonia to a given volume of alcohol, preferably ethanol. After homogenization, a silica precursor of tetraalkoxysilane type, preferably tetraethoxysilane, is added, and the reaction takes place for at least 12 hours with moderate stirring and with the temperature being controlled.

Step 1a) can be carried out according to various embodiments.

According to a first embodiment, a macromolecule having a hydrophilic chain that ends with a polymerizable function F_{C} is used as coupling agent C, said macromolecule being referred to hereinafter as macromonomer. Said macromonomer is brought into contact with the initial particles, and the reaction medium is stirred for a certain period of time. As examples of macromonomers, mention may be made of poly(ethylene oxide)s, hydroxycelluloses, poly(vinylpyrrolidone)s, poly(acrylic acid)s and poly-(polyvinyl alcohol)s, said compounds carrying the abovementioned free-radical polymerizable function F_{C}. The polymerizable function F_{C} can, for example, be a vinyl group, a methacrylate group or an allyl group. When the initial particles are silica particles, a poly(ethylene glycol) monomethyl ether methacrylate can advantageously be used as macromonomer. To determine the amount of macromonomer required, the adsorption isotherm for the chosen macromonomer on the initial particle can, for example, be measured. If an adsorption is effectively observed, those skilled in the art will be able to carry out preliminary trials using low concentrations (which are in general sufficient to avoid promoting the nucleation of particles in the continuous phase during step 1b)), so as to determine the optimum conditions. The amount of time required to ensure complete adsorption of the macromonomer onto the initial particle during step 1a) should be adjusted according to the nature of the macromonomer and of the initial particle. A period of 24 hours is generally sufficient.

According to a second embodiment, step 1a) can be carried out by covalent grafting of a coupling agent C carrying a function F_{C} which is copolymerizable with the precursor(s) of the polymer. When the material constituting the initial particles is a mineral oxide, the coupling agent fixed by covalent grafting can be chosen from organometallic derivatives such as organosilanes corresponding to the formula R¹ₙSiX₄₋ₙ (n=1 to 3), in which X is a hydrolyzable group (for example, a halogen or an alkoxide) and R¹ is a radical comprising the abovementioned functional group F_{C}. As an example of such a coupling agent, mention may be made of allyl trialkoxysilanes. The surface of the inorganic nanoparticle is then modified so as to allow fixing of the growing polymer nuclei. In this case, the method for modifying the inorganic nanoparticles consists in adsorbing the coupling agent to the surface of the nanoparticles, and then in heating the reaction medium to the required temperature so as to ensure covalent grafting of the compound by means of the hydrolysis-condensation reaction of the groups X with the hydroxyl surface groups. The excess of the various reactants can be eliminated from the reaction medium at the end of the method by dialysis. The nanoparticles thus obtained are made up of a core made of inorganic material carrying, at its surface, organic substituents that have a free polymerizable function. This method is particularly advantageous when the mineral oxide is a silica. When the material constituting the initial particles is a metal, the coupling agent fixed by covalent grafting can be chosen from organothiols RSH and amines RNH₂ in which R is a substituent carrying the functional group F_{C} having an affinity for the polymer or a precursor of said polymer. As an example of such a coupling agent, mention may be made of 4-vinylaniline.

In a third embodiment, the initial particles are suspended at a pH close to neutrality such that they are surface-charged, in the presence of an amphiphilic compound consisting of a hydrophobic part that has a polymerizable group and of a polar head that carries a charge opposite to that of the surface. The amphiphilic compounds can adsorb strongly to the surface of the initial particle via electrostatic interactions. These amphiphilic molecules, which simultaneously exhibit a surface-active (surfactant) nature and which are monomers, are known to those skilled in the art as surfmers. As examples of surfmers, mention may be made of compounds derived from styrene sulfonates (having a negatively charged hydrophilic polar head) and quaternary alkylammoniums (having a positively charged polar head), the two types of compounds carrying a hydrophobic group (such as a long alkyl chain, for example) that ends with a polymerizable function. N,N-dimethyl-N-[11-(p-vinylbenzoyl-oxy)undecyl]octadecylammonium bromide, the synthesis of which is described by Jung et al., in Langmuir 2000, 16, 4185-4195, is a typical case of polymerizable quaternary ammonium.

Step 1b) can be carried out by bringing the modified particles obtained at the end of step 1a) into contact with one or more monomers that are precursors of the polymer, in the presence of a polymerization initiator, said monomer(s) carrying functions F_{B} capable of reacting with the functions F_{C}. The polymerization process of step 2b) can be stopped by cooling the reaction medium to ambient temperature or adding a radical polymerization inhibitor, and then dialyzing the cooled reaction medium so as to eliminate the traces of monomer and of initiator which have not reacted, and also the excess of surfactant and of possible inhibitor.

The monomer is preferably chosen from compounds having a vinyl group which plays the role of polymerizable function F_{B}. Such compounds correspond, for example, to the formula H₂C═CRR′ in which R and R′ have the meaning given above. Mention may in particular be made of monomers that contain a vinyl group, in particular styrene, α-methylstyrene, vinyl-pyridine, vinyl acetate or vinyl propionate. Mention may also be made of monomers comprising an acrylic group, in particular vinyl esters of the methyl methacrylate, ethyl acrylate, butyl acrylate, ethylhexyl methacrylate, acrylonitrile or methacrylonitrile type.

To obtain a crosslinked polymer nodule, a mixture of monomers comprising one or more of the monomers above, and a crosslinking monomer comprising a second group F_{B}, is used. As examples of crosslinking monomers, mention may be made of ethylene glycol dimethacrylate (EGDMA), diethylene glycol dimethacrylate, vinyl methacrylate or divinylbenzene. The proportion of monomer capable of crosslinking, relative to the monofunctional monomer, is preferably from 1 to 10% by weight.

Water or a water-alcohol (preferably ethanol) mixture in water/alcohol proportions of between 100/0 and 50/50 is preferably used as solvent.

The surfactant present in the reaction medium in step 1b) makes it possible to carry out the reaction in an emulsion or in a miniemulsion. It can be chosen from anionic, cationic or nonionic surfactants. For the nonionic surfactants, polyoxyethylenated alkylphenols can, for example, be used. As an anionic surfactant, an alkylbenzene sulfonate or an alkyl sulfonate can, for example, be used. When the polymerization is carried out in a dispersion, a stearic stabilizer, such as a poly(N-vinylpyrrolidone) or hydroxypropylcellulose, is added to the reaction medium. Some of these compounds were mentioned as a coupling agent and consequently perform a double function.

The implementation of step 2) depends, firstly, on the nature of the functions F1 that it is desired to graft onto the zone Z1 of the particles obtained at the end of step 1), and, secondly, on the nature of the coupling agent carrying the function F_{C} used in the first step.

When the coupling agent is a macromonomer fixed to the initial particle by adsorption, it can be removed simply from the zone Z1 by desorption, after masking of the zone Z2. The zone Z1 then constitutes an unmodified oxide surface which can be modified using any compound capable of reacting with the hydroxyl functions which are at the surface of the inorganic materials constituting the initial particles, on condition that said compound is not a solvent for the polymer used to mask the zone Z2 in step 1). By way of example of compounds, mention may be made of silanes, and in particular trialkoxysilanes carrying a functional group —CH₂—CH₂—CH₂X in which X is an amine, a thiol or a glycidoxy group, said group optionally allowing subsequent couplings with other molecules. The treatment of the zone Z1 using a trialkoxysilane can be carried out in any solvent which is not a solvent for the polymer. The same solvent as that of step 1) will advantageously be used.

When, during step 1), the coupling agent carrying the function F_{C} is grafted via a covalent bond onto the initial inorganic particle, it is, a priori, more difficult to obtain a surface of zone Z1 similar to the surface of the initial particles before step 1). When the nature of the polymer to be fixed allows the use of a coupling agent carrying, as function F_{C}, the function F1 that it is desired to fix to the zone Z1, step 2) is carried out at the same time as step 1). When F1 does not correspond to F_{C}, the attempts to remove said function F_{C} before fixing the functions F1 can result in detachment of the polymer nodules. It is then preferable to convert the function F_{C} to a function F1 by means of conventional chemistry methods, which are within the scope of those skilled in the art.

The implementation of step 3), i.e. the demasking of the zone Z2 of the nanoparticles by removal of the polymer nodule, is advantageously carried out by a physical process.

In a first embodiment, step 3) comprises a first step 3a) during which the polymer nodule is detached from the modified hybrid particles, by ultracentrifugation or by sonication, and a step 3b) during which the polymer particles released by the demasking are removed. Step 3a) can be carried out by ultracentrifugation or by sonication of an aqueous suspension of modified hybrid particles, under the conditions which generate a shear force sufficient to detach the polymer nodules from the inorganic part of the modified hybrid particles. The suspension can also contain a surfactant. The determination of the conditions of implementation specific to each particular case is within the scope of those skilled in the art. The ultra-centrifugation can be carried out, for example, using a Beckman TLX-120 ultracentrifuge which generates high centrifugal forces for small samples (4×1.5 ml) and which provides speeds ranging from 5 000 to 120 000 revolutions per minute (i.e. 627 000 g) with a temperature control of 2 to 40° C. The sonication can be carried out, for example, in a Fisherbrand FB 11002 ultrasonic tank, at maximum power. For step 3b), the suspension containing the inorganic particles and the organic particles obtained after demasking is subjected to an ultracentrifugation, adjusting the speed, the duration and the number of cycles so as to obtain two phases each having a purity of at least 99%. In a specific embodiment, the suspension is brought to a density of between 1.05 and 2, by adding a water-miscible compound of high density, for example a polyalcohol, a polyether or a polyamine, in the presence of a surfactant. The surfactant prevents agglomeration of the particles in the suspension. The density range targeted promotes creaming of the organic nanoparticles and sedimentation of the inorganic particles.

In a second embodiment, the demasking of the modified hybrid particles and the separation of the released organic particles are carried out simultaneously. For example, when the particles comprise a polymer nodule fixed using a macromonomer as coupling agent, a suspension of said particles also containing a surfactant and a water-miscible compound of high density (as defined above) is subjected to an ultracentrifugation. The surfactant causes demasking by displacement of the macromonomer from the surface of the inorganic particle and facilitates dispersion of the particles by stabilizing the suspension for the separation. The high-density compound makes it possible to increase the density of the water and its viscosity limits the aggregation. The ultracentrifugation makes it possible to introduce the energy required for the breaking of hydrogen bonds and to accelerate the separation which promotes the sedimentation of the inorganic particles while at the same time maintaining the polymer particles in the supernatant.

During step 4), the zone Z2 of the inorganic particles, which has again become free after demasking, can be functionalized with functions F2. For example, when the nonmasked surface zone Z1 of the nanoparticles is functionalized using trialkoxysilanes and consequently carries alkyl groups F1, it is possible to envision fixing amine groups onto the zone Z2 that is masked during the reaction with the trialkoxysilane and then demasked. This step can be carried out by adding, for example, γ-aminopropyltrimethoxysilane (γ-APS) in the presence of ammonia to a suspension of particles demasked after removal of the polymer nodules.

The presence of the amine groups and the regioselective localization thereof at the surface of the final particles can be revealed by the fixing of gold nanoparticles, the affinity of which for amine functions has been described, in particular by S. L. Westcott et al. (Langmuir 1998, 14, 5396-5401). The localization of the gold particles fixed to the amine groups is visible on TEM micrographs.

The regioselectively difunctionalized particles of the invention can be used in many technical fields. Appropriate modification of the amphiphilic nature thereof as a function of the chemical characteristic thereof, and the choice of a specific size, make it possible to stabilize numerous “oil/water” emulsions. Thus, the particles could be used in particular in the paint industry. The surfactants currently used in aqueous paints containing white pigments (for example, TiO₂) gradually cause yellowing of the paint. TiO₂ particles surface-modified so as to exhibit a zone Z1 carrying hydrophobic groups and a zone Z2 carrying hydrophilic groups could successively play the role of paint stabilizer and then of white pigments.

The present invention is described in greater detail by means of the following examples which are given by way of illustration and to which it is not, however, limited.

### EXAMPLE 1

### Preparation of Silica Nanoparticles

A basic aqueous-alcoholic solution was prepared by adding 40 ml of an aqueous solution of ammonia, containing an average percentage by mass of 27% of ammonia, to 500 ml of ethanol at 50° C. with argon sparging. After homogenization, 15 ml of tetraethoxysilane were added as silica precursor, and the reaction medium was left for 15 hours with moderate stirring. Silica nanoparticles having a diameter Φ of approximately 100 nm were thus obtained.

After the end of the synthesis, the excess reactants were removed by successive dialyses in dialysis bags immersed in distilled water so as to exchange the ethanol solvent against water. The dialysis bags consist of a regenerated cellulose membrane. The dialysis is considered to be over when the pH of the water outside the membrane approaches neutrality (between 7 and 8). The suspension obtained was concentrated by immersing the dialysis bag in a concentrated aqueous solution containing approximately 200 g.l⁻¹ of polyethylene glycol (35 000 g.mol⁻¹). The concentration of silica in the suspension was subsequently determined by measuring the mass of a dry extract, with a view to determining the concentration by mass of silica in the concentrated suspension obtained after the final dialysis.

### EXAMPLE 2

### Modification of the Surface of the Silica Nanoparticles by Adsorption of a Macromonomer

An aqueous solution of poly(ethylene glycol) monomethyl ether methacrylate (which is a macromolecule having a hydrophilic chain that ends with a polymerizable function) was added to a concentrated suspension of nanoparticles of colloidal silica obtained after the final dialysis of the method of example 1, in proportions such that the amount of macromonomer is close to 2 mg per m² of silica (it being recalled that the surface of a silica nanoparticle is taken to be equal to 4×π×r², r being the mean radius of the nanoparticle). After the mixture had been stirred for 6 hours, the degree of adsorption of the macromolecule onto the silica was considered to be satisfactory. Dialysis was carried out under the conditions mentioned above.

### EXAMPLE 3

### Modification of the Surface of the Silica Nanoparticles by Grafting a Functional Trialkoxysilane

A large excess of methacryloxymethyltriethoxysilane (approximately 0.15 μmol per m² of surface of silica) was added to a suspension of silica obtained according to the method of example 1, after having brought the reaction medium back to ambient temperature. The reaction medium was left to stand for 12 hours in order for the compound to adsorb to the surface of the nanoparticles, and then the reactor was brought to 100° C. in order to ensure the covalent grafting of the compound by means of a hydrolysis-condensation reaction of the methoxy groups with the silanol groups of the surface of the silica nanoparticles. The suspension of modified nanoparticles obtained was subsequently subjected to dialysis.

### EXAMPLE 4

### Preparation of Hybrid Nanoparticles

Surface-modified silica nanoparticles obtained according to the method of example 2 were modified by fixing a nodule of polystyrene in the following way:
a nonionic surfactant (0.3 g diluted in 2 ml of distilled water) of polyethylene glycol nonylphenyl ether type was added to 100 ml of a suspension of modified nanoparticles at the concentration of 10 g.l⁻¹, such that the concentration of surfactant (3 g.l⁻¹) was greater than the critical micellar concentration (CMC) of said surfactant;
styrene monomer (10 g, i.e. 11 ml) was added such that its concentration was 100 g.l⁻¹ and the mixture was vigorously stirred in order to ensure that the suspension obtained was homogeneous;
the suspension was degassed by circulating a stream of nitrogen, and the temperature was gradually increased to 70° C., which is the standard condition for styrene polymerization;
when the thermal equilibrium was reached, after about fifteen minutes, a free-radical initiator, sodium persulfate, was added in the proportion of 0.5% by mass of monomer (0.05 g diluted in 2 ml of distilled water), in order to initiate the polymerization reaction. After homogenization, the stirring was brought back to 300 rpm;
after a period of 60 min, the reaction medium was brought back to ambient temperature, and then dialysis was performed under the conditions described above in order to eliminate the traces of monomer and of initiator that had not reacted, and also the excess surfactant.

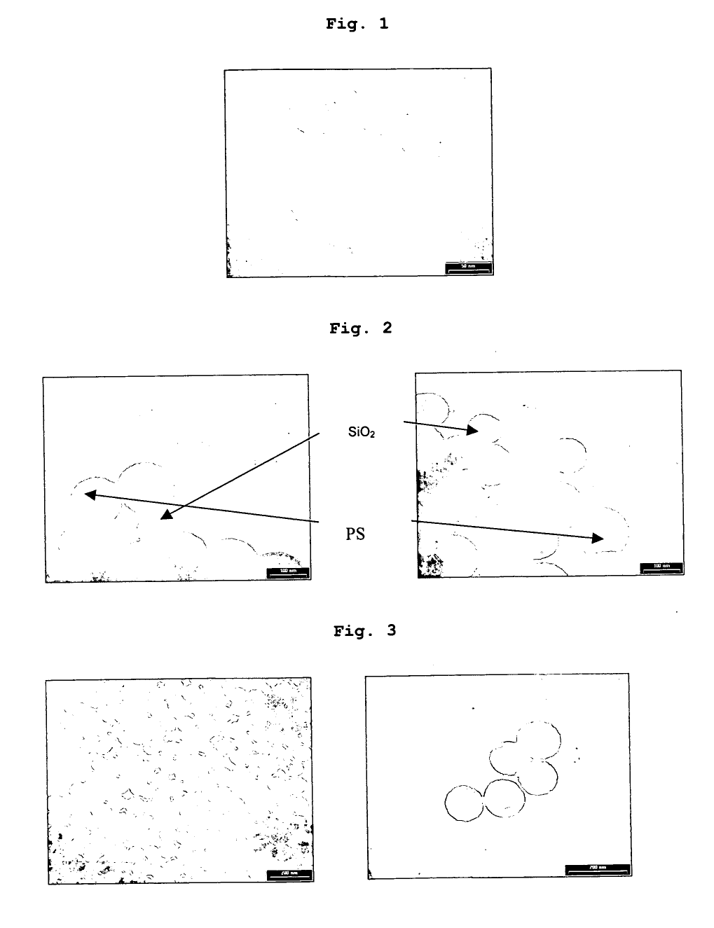

The unsymmetrical nanoparticles obtained were characterized by TEM. FIG. 1 represents a micrograph of a hybrid nanoparticle obtained, which has a “snowman” shape in which the size of the polymer part is greater than that of the silica part, which remains that of the silica nanoparticles of origin, i.e. 100 nm.

Similar results were obtained by reproducing the procedure of this example using the particles obtained in example 3.

### EXAMPLE 5

### Functionalization of the Nonmasked Inorganic Part of Hybrid Nanoparticles

8 ml of suspension of hybrid nanoparticles in ethanol, obtained according to example 4, are mixed with 640 μl of aqueous ammonia and 10 μl of trimethylethoxysilane. The reaction takes place for 3 hours at ambient temperature with stirring, and the reaction mixture is then brought to 50° C. for one hour in order to stabilize the covalent bonds between the organosilane and the silica nanoparticles without degrading the polystyrene mask. A sample is then diluted in ethanol and then examined by TEM. It appears that the grafting of the organosilane onto the free surface of the silica does not affect the geometry of the silica-polystyrene assembly and the mask makes it possible to protect a part of the silica without impeding the functionalization of the other part.

### EXAMPLE 6

### Demasking of the Nanoparticles by Centrifugation

The addition of a surfactant to the suspension of modified hybrid particles before centrifugation makes it possible to prevent agglomeration of the particles after centrifugation. Sodium dodecyl sulfate (SDS), at a concentration in solution greater than its critical micellar concentration (CMC), is an appropriate surfactant. Several trials were carried out using nanoparticles obtained in example 5, in order to verify the influence of the concentration of surfactant.

For an SDS concentration of the order of 5 CMC, the masking is seen to commence starting from a centrifugation speed of the order of 40 000 rpm, and the demasking is complete from approximately 50 000 rpm. If the concentration of SDS is much higher, for example of the order of 7 CMC, complete demasking is obtained starting from a centrifugation speed of the order of 20 000 rpm. The demasking of the modified hybrid particles can be observed on the TEM micrographs of the particle suspensions after centrifugation. The polymer nodules detached from the modified hybrid particles have the imprint of the inorganic particle in the form of a notch that is visible on said TEM micrographs.

FIG. 2 represents two TEM micrographs of a particle suspension obtained after centrifugation of a suspension of hybrid particles obtained according to the method of example 5. The centrifugation was carried out at 50 000 rpm for 15 minutes at 20° C., and the pellets were redispersed by vortexing and by sonication. “SiO₂” denotes the demasked silica particles, and “PS” denotes the polystyrene nodules exhibiting a notch corresponding to the imprint of the silica particle. The demasking of the silica particles can thus be evaluated by counting on the MET photographs (50 to 100 objects on average). The degree of deprotection corresponds to the ratio of the number of polystyrene particles exhibiting a notch, to the total number of organic particles present.

### EXAMPLE 7

### Demasking of Particles by Sonication

In a particular embodiment, a suspension, in a solution of SDS at 4.7 CMC, of silica particles masked with a polystyrene nodule, obtained in example 5, is subjected to sonication in a Fisherbrand FB 11002 ultrasonic tank, at maximum power. A duration of the order of 10 min makes it possible to obtain demasking without degradation of the polystyrene particles due to heating. Here again, the demasking is observed on the TEM micrographs of the particle suspensions, showing polymer nodules detached from the inorganic particles, which have the imprint of the inorganic particle in the form of a notch.

### EXAMPLE 8

### Separation of the Inorganic Particles and of the Polymer Particles After Demasking

A suspension of demasked particles obtained at the end of example 6 was subjected to centrifugation for approximately 15 min at a speed of 20 000 rpm (i.e. 17 417 g), so as to sediment the inorganic particles. The initial supernatant was then replaced with a mixture of water-glycerol at 22%/SDS at 4.7 CMC, and. three successive centrifugations at 50 000 rpm (i.e. 108 854 g) at 20° C. for 15 minutes were carried out. The glycerol makes it possible to increase the density of the water and its viscosity limits aggregation. Finally, the ultracentrifugation makes it possible to both introduce the energy required for the breaking of the hydrogen bonds and to accelerate the separation which promotes the sedimentation of the silica particles while at the same time maintaining the polystyrene particles in the supernatant. The pellet was dispersed directly in water, while the supernatant was subjected to dialysis against purified water. FIG. 3 represents the TEM micrographs for the silica particles contained in the pellet after centrifugation (on the left) and for the polystyrene particles contained in the supernatant (on the right).

Similar results were obtained by reproducing the procedure of the present example using example 7.

### EXAMPLE 9

### Demasking of the Nanoparticles by Ultracentrifugation and Simultaneous Separation of the Species

The nanoparticles obtained by means of the method of example 4 were washed by sedimentation by centrifuging them at 20 000 rpm for 15 minutes. The demasking and the isolation of the silica beads were carried out simultaneously by means of three successive centrifugations in a water/SDS/glycerol mixture at 50 000 rpm for 20 minutes. Three phases form: a white pellet containing the silica; an opaque supernatant containing polystyrene and some elements M consisting of a silica nanoparticle to which two polymer nodules are fixed; a white crown at the top originating from the creaming of the polystyrene. This method of demasking thus makes it possible to isolate the silica nanoparticles in which a part of the surface is modified with trimethylethoxysilane, since the pellet resulting from the centrifugation contains only nanoparticles of this type.

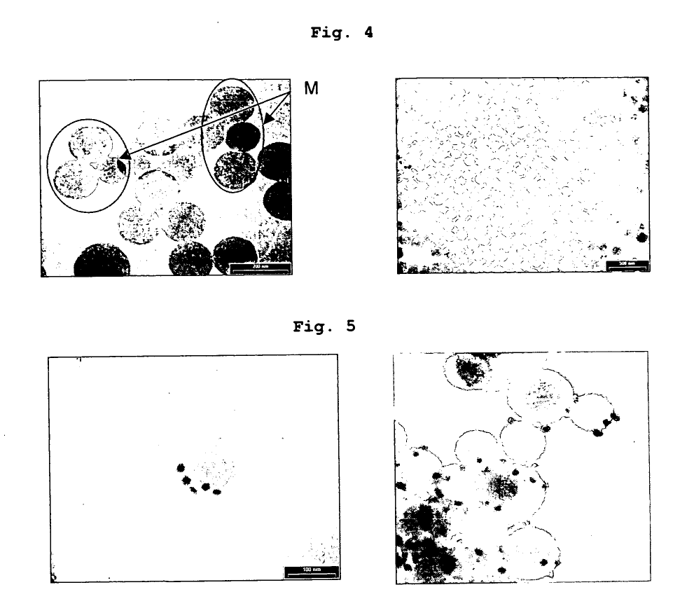

FIG. 4 is a TEM micrograph representing, on the left, the opaque supernatant containing the isolated polymer nanoparticles and the composite particles M, and, on the right, the modified silica nanoparticles present in the pellet.

### EXAMPLE 10

### Post-Functionalization of the Demasked Silica Nanoparticles

640 μl of aqueous ammonia and 6 μl of γ-APS are added to 8 ml of a suspension in ethanol of silica nanoparticles extracted from the pellet in the method of example 6. The reaction takes place for 3 hours at ambient temperature with stirring, and the reaction mixture is then brought to 50° C. for one hour in order to stabilize the covalent bonds between the organosilane and the silica nanoparticles.

The fixing of the amino groups provided by the γ-APS is verified by fixing gold nanoparticles in the following way. The nanoparticle suspension obtained after treatment with γ-APS is dispersed in water, and then 24 ml of colloidal gold solution are added and the mixture is left at ambient temperature for at least four hours, with stirring. The sedimented nanoparticles are then washed with water, and then observed by TEM. FIG. 5 represents the silica nanoparticles obtained after treatment with the gold nanoparticles. It thus appears that the polymer nodule formed on the silica nanoparticles in example 3 has played the role of a mask during the trimethoxysilane group fixing step described in example 4. Thus, the silica nanoparticles are clearly difunctional and unsymmetrical since the NH₂ functions (identifiable by means of the gold nanoparticles that have become fixed thereto) are grouped together in one zone of the surface of the nanoparticles and the CH₃ functions are grouped together in a distinct zone of the surface of the nanoparticles.

The gold nanoparticles can be obtained by means of the methods of the prior art, for example by means of the “citrate process” method (cf. A. Meier, et al., Nanoparticles in solids and solutions, 421-449, 1996), or by means of the “THPC (tetrakis(hydroxymethyl)phosphonium chloride) process” method (cf. T. Pham, et al., Langmuir, 18, 4915-4920, 2002).

1. Nanoscale or mesoscopic particles comprised of an inorganic material, wherein the surface thereof is divided into two zones Z1 and Z2, the zone Z1 carries groups F1 and the zone Z2 carries groups F2 different from the groups F1, the zone Z1 being free of groups F2 and the zone Z2 being free of groups F1.

2. The particles as claimed in claim 1, wherein the area of each zone represents at least 5% of the total area of a particle.

3. The particles as claimed in claim 1, wherein the area of each zone represents at least 10% of the total area of a particle.

4. The particles as claimed in claim 1, wherein the inorganic material A is a mineral oxide or a metal.

5. The particles as claimed in claim 4, wherein the inorganic material is a mineral oxide chosen from silica, iron oxides, aluminosilicates, titanium dioxide and alumina.

6. The particles as claimed in claim 4, wherein the metal is chosen from metals that are stable in an aqueous medium.

7. The particles as claimed in claim 1, wherein the inorganic material A is silica.

8. A method for preparing the particles as claimed in claim 1, the method comprising the following steps:
1) masking a zone Z2 of the surface of the initial particles by fixing a polymer nodule thereto;
2) treating the masked particles obtained at the end of step 1) in order to modify the nonmasked surface zone Z1 of said particles;
3) removing the polymer nodule after modifying the zone Z1;
4) optionally, modifying the surface of the zone Z2 of the particles following the demasking process.

9. The method as claimed in claim 8, wherein the initial particles used in step 1) have the shape of a sphere, an ellipse, a disk, a block or a rod.

10. The method as claimed in claim 8, wherein the polymer used for masking the zone Z2 of the surface of the initial particles comprises recurrent units —CH₂—CRR′—, which may be identical or different, in which:
R represents H or an alkyl group,
R′ represents H, an alkyl group, an aryl group, an alkylaryl group, an alkenylaryl group, a pyridyl group, a nitrile group, a group —COOR″ or a group —OC(O)R″ in which R″ is H, an alkyl or an alkenyl.

11. The method as claimed in claim 10, wherein R, R′and/or R″ represent, independently of one another, an alkyl group or an aryl group which carries a functional group.

12. The method as claimed in claim 10, wherein said polymer is crosslinked or noncrosslinked.

13. The method as claimed in claim 10, wherein said polymer is a polystyrene or a copolymer of styrene and of divinylbenzene which is particularly preferred as material for the polymer nodule.

14. The method as claimed in claim 8, wherein step 1) comprises the following steps:
1a) modifying the surface of the initial particles using a coupling agent C which comprises a function F_{C} which has an affinity for one or more precursors of the polymer B;
1b) bringing the modified initial particles obtained at the end of step 1a) into contact with the precursor(s) of the polymer B, in the presence of a free-radical initiator and of a surfactant in solution in a solvent, in proportions that allow the formation of one polymer nodule per initial particle.

15. The method as claimed in claim 14, wherein the coupling agent, hereinafter referred to as macromonomer, is a macromolecule having a hydrophilic chain that ends with a polymerizable function F_{C}.

16. The method as claimed in claim 15, wherein the macromonomer is chosen from poly(ethylene oxide)s, hydroxycelluloses, poly(vinylpyrrolidone)s, poly(acrylic acid)s and poly(polyvinyl alcohol)s, said compounds carrying said function F_{C}.

17. The method as claimed in claim 14, wherein step 1a) is implemented by covalent grafting of a coupling agent carrying a function F_{C} which is copolymerizable with the precursor(s) of the polymer.

18. The method as claimed in claim 17, wherein the material constituting the initial particles is a mineral oxide, and the coupling agent fixed by covalent grafting is chosen from organometallic derivatives such as organosilanes corresponding to the formula R¹ₙSiX₄₋ₙ (n=1 to 3), in which X is a hydrolyzable group and R¹ is a radical comprising said functional group F_{C}.

19. The method as claimed in claim 14, wherein the initial particles are suspended at a pH close to neutrality such that they are surface-charged, in the presence of an amphiphilic compound comprised of a hydrophobic part that has a polymerizable group and of a polar head that carries a charge opposite to that of the surface.

20. The method as claimed in claim 19, wherein the amphiphilic compound is chosen from compounds derived from styrene sulfonates (having a negatively charged hydrophilic polar head) and quaternary alkylammoniums (having a positively charged polar head), the two types of compounds carrying a hydrophobic group that ends with a polymerizable function.

21. The method as claimed in claim 14, wherein step 1b) is carried out by bringing the modified particles obtained at the end of step 1a) into contact with one or more monomers that are precursors of the polymer, in the presence of a polymerization initiator, said monomer(s) carrying functions F_{B} capable of reacting with the functions F_{C}.

22. The method as claimed in claim 14, in which the coupling agent used in step 1) is a macromonomer fixed to the initial particle by adsorption, wherein, in step 2), the macromonomer is removed from the zone Z1 by desorption, and then the particles are brought into contact with a compound capable of reacting with the hydroxyl functions which are at the surface of the zone Z1.

23. The method as claimed in claim 22, wherein said compound is a trialkoxysilane carrying a functional group —CH₂—CH₂—CH₂X in which X is an amine, a thiol or a glycidoxy group, said group optionally allowing subsequent couplings with other molecules.

24. The method as claimed in claim 14, wherein the coupling agent carrying the function F_{C} is grafted via a covalent bond onto the initial inorganic particle, said function F_{C} being the function F1 that is to be fixed to the zone Z1.

25. The method as claimed in claim 14, wherein the coupling agent carrying the function F_{C} is grafted via a covalent bond onto the initial inorganic particle, and in that the functions F_{C} are converted to functions F1 by a chemical process.

26. The method as claimed in claim 14, wherein step 3) is carried out by centrifugation or by sonication.
